(19) United States
(12) Patent Application Publication
(10) Pub. No.: US 2011/0003263 A1
(43) Pub. Date: Jan. 6, 2011

(54) TWEEZERS FOR ORTHODONTIC LOCK

(76) Inventor: Charles Clor, Colmar (FR)

Correspondence Address: YOUNG & THOMPSON, 209 Madison Street, Suite 500, Alexandria, VA, 22314, US

(21) Appl. No.: 12/918,858

(22) PCT Filed: Jan. 30, 2009
(86) PCT No.: PCT/FR09/50144

§ 371 Date: Aug. 23, 2010

(30) Foreign Application Priority Data
Feb. 22, 2008 (FR) 0800956

(51) Int. Cl. A61C 3/00

(52) U.S. Cl. 433/4

(57) ABSTRACT

Tweezers including two manipulating arms with elastic elements that are terminated by two bits for gripping the lock also include: two projections facing one another, made on the two inside surfaces of the two bits, able to work in a removable manner, with adjustment, with two recesses opposite one another made on the two lateral surfaces of the lock, at least one extension that extends from a free end of at least one of the bits with an incline and over a suitable length at which the extension is able, when the tweezers are in use, to extend essentially parallel to the axis of the tooth in the direction of the occlusal surface, at least one return extending crosswise from a free end of at least one extension, able, when the tweezers are in use, to come to a stop on the occlusal surface of the tooth.

The invention relates to tweezers for positioning an orthodontic lock on a tooth, an orthodontic unit that comprises such tweezers and such an orthodontic lock for a given tooth, a system comprising a number of such units, and finally the process for using such an orthodontic unit.

In orthodontia, locks—commonly called “brackets”—designed to correct the alignment of a patient's teeth are known. The document WO 2006/097657 describes such a lock in an embodiment where the lock is self-locking.

For the positioning and the installation of such locks, tweezers of different shapes (straight bits, angular bits, wide bits, fine bits, bent bits, . . . ) are used. In certain embodiments, the tweezers comprise a positioning blade of the lock.

Gauges for positioning locks on the teeth that are to accommodate them and that are designed for vertical adjustment of the height of the lock on the tooth are also known. In certain embodiments, such a gauge is integrated into tweezers with an adjusting screw.

The documents U.S. Pat. No. 5,607,299 and U.S. Pat. No. 6,447,291 describe such orthodontic locks and such tweezers. The document FR-A-2 901 994 describes an installation template for an orthodontic device.

The known devices have a certain number of constraints, limits, and more generally drawbacks.

The tweezers with gauges are little used today, taking into account the risks of errors that they exhibit, taking into account that the thread can be moved at the wrong time. In addition, their implementation is complex.

More generally, the known devices have, as a first drawback, a two-stage implementation: placing the lock on the tooth by means of the tweezers and then resting on a tray, using the height gauge based on the tooth. However, between these two stages, the lock can be moved on the tooth at the wrong time or the glue can harden when the lock has not yet been placed in its final position.

A second drawback relates to the gauges that are used, which are ill-suited in the case of locks that comprise a torque and an incline of the groove or “slot,” as it is usually called, for accommodating the arc, or else in the case of self-tying locks, whereby the latter have to be open when the gauge is used.

A third drawback is that the actual tweezers do not make it possible to grip the lock in a known and controlled manner.

There is therefore the need for tweezers for positioning the orthodontic locks on teeth (or on models of teeth) that enable a positioning that is known, precise, and reproducible at the same time, without the risk of error or unexpected events, and thereby easy and fast.

For this purpose, and according to a first aspect, the invention proposes tweezers for positioning an orthodontic lock on a tooth, comprising two manipulating arms with elastic means that are terminated by two bits for gripping the lock for the purpose of positioning it and most often interlocking it on a tooth at the desired location and with the desired orientation, also comprising:
Two projections facing one another, made on the two inside surfaces of the two bits, able to work in a removable manner, with adjustment, with two recesses that are opposite one another and that are made on the two lateral surfaces of the lock,
At least one extension that extends from a free end of at least one of the bits with an incline and over a suitable length at which the extension is able, when the tweezers are in use, to extend essentially parallel to the axis of the tooth in the direction of the occlusal surface,
At least one return extending crosswise from a free end of at least one extension, able, when the tweezers are in use, to come to a stop on the occlusal surface of the tooth.

According to one embodiment, the two projections are coaxial and are able to work with two coaxial recesses, with the possibility of relative pivoting at least within a certain range.

According to a first embodiment, the two projections are coaxial with an axis that is essentially perpendicular to the respective inside surfaces of the bits.

According to a second embodiment, the two projections are coaxial with an inclined axis relative to the respective inside surfaces of the bits.

According to a first embodiment, the two bits have two inside surfaces that are parallel to the plane of symmetry of the tweezers.

According to a second embodiment, the two bits have two parallel inside surfaces, inclined relative to the plane of symmetry of the tweezers.

According to a first embodiment, the tweezers comprise a return extending essentially in a direction that can be located at least essentially orthogonal to the longitudinal plane of the tooth.

According to a second embodiment, the tweezers comprise a return extending in two essentially perpendicular directions, a first direction that can be located at least essentially orthogonal to the longitudinal plane of the tooth and a second direction that can be located at least essentially in the longitudinal plane of the tooth in the direction of its transverse plane.

According to one embodiment, the tweezers are such that their dimensions and inclines are especially adapted to the tooth for which they are intended and according to the type of technique used by the orthodontist.

According to a first embodiment, the tweezers comprise a single extension and a single return on only one of the bits.

According to a second embodiment, the tweezers comprise two extensions and two returns, one for each bit.

According to a particular embodiment, the tweezers are especially designed for the lower archway of the jaw, the extension extending upward from a bit.

According to another particular embodiment, the tweezers are especially designed for the upper archway of the jaw, the extension extending downward from a bit.

According to a second aspect, the invention relates to a unit that comprises tweezers as just described and an orthodontic lock that has two recesses opposite one another that are made on the two lateral surfaces, able to work with the two projections of the tweezers in a removable way and with adjustment.

According to a third aspect, the invention relates to a system that comprises a number of units as just described, whereby each unit corresponds to one of the teeth that has to accommodate an orthodontic lock.

According to a fourth aspect, the invention relates to a process for using an orthodontic unit as described above, in which:
A start is made from a position in which an orthodontic lock and tweezers adapted to the lock and to the tooth d in question are used,
The lock is positioned between the two bits of the tweezers and for this purpose, the projections of the tweezers are arranged in the recesses of the lock, whereby the inside surfaces of the bits come against the lateral surfaces of the lock, by the action of elastic means on the two manipulating arms of the tweezers, the support surface of the orthodontic lock being located toward the outside end of the tweezers,
The tweezers that are thus equipped with the orthodontic lock are manipulated so as to bring the support surface fa toward the surface of the tooth that has to accommodate the orthodontic lock,
The orthodontic lock is positioned at the desired location on the tooth, with the desired orientation, and for this purpose, the return of the tweezers is brought to a stop on the occlusal surface of the tooth.

According to one embodiment, the process is such that in addition and at the end, the engagement of the lock on the tooth is ensured.

Several embodiments of the invention are now described using drawings in which:

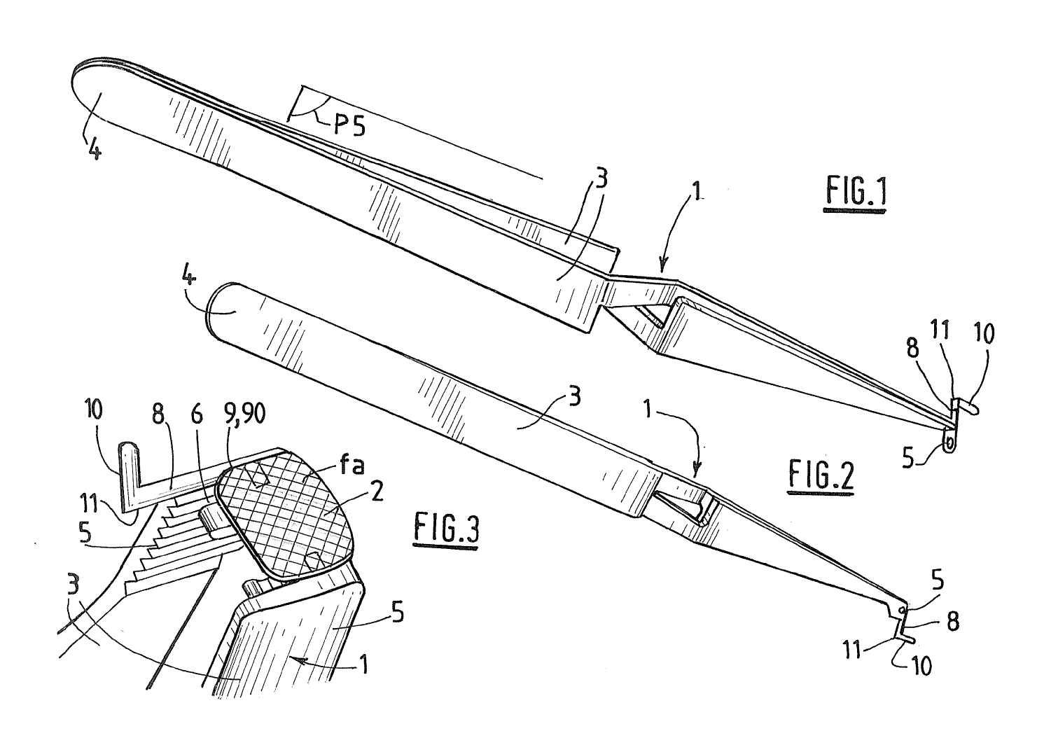

FIGS. 1 and 2 are two perspective views of tweezers according to the invention, respectively for the upper archway and for the lower archway,

FIG. 3 is a partial perspective view, in larger scale, of tweezers with an associated orthodontic lock,

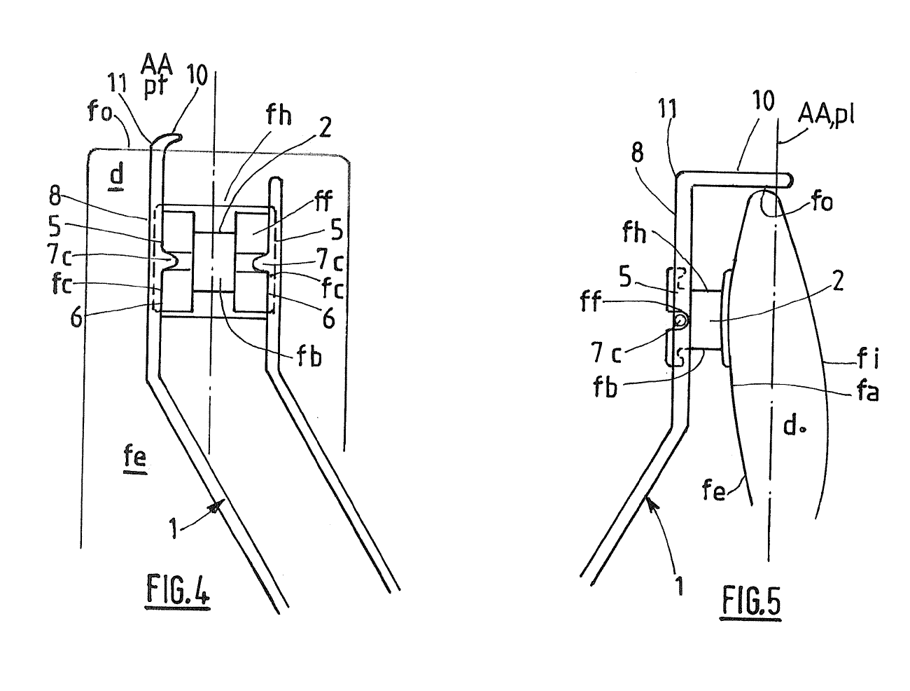

FIG. 4 is a front elevation view of tweezers for the lower archway, with an associated orthodontic lock in position on a tooth,

FIG. 5 is a side view of tweezers such as those of FIG. 4, for the lower archway, with an associated orthodontic lock in position on a tooth,

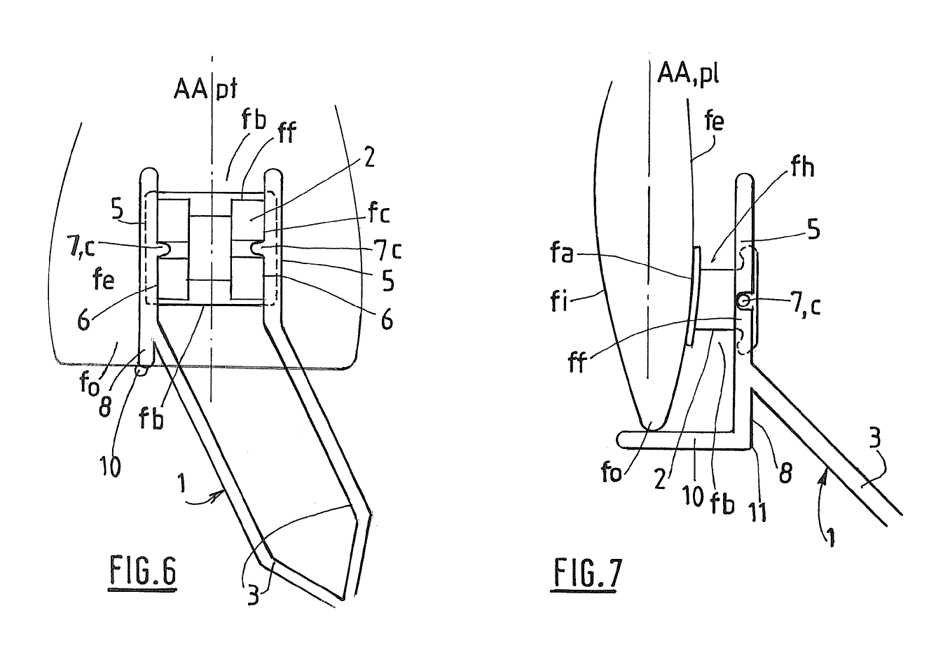

FIG. 6 is a front elevation view of tweezers for the upper archway with an associated orthodontic lock that is in position on a tooth,

FIG. 7 is a side view of tweezers such as those of FIG. 6 for the upper archway, with an associated orthodontic lock in position on a tooth,

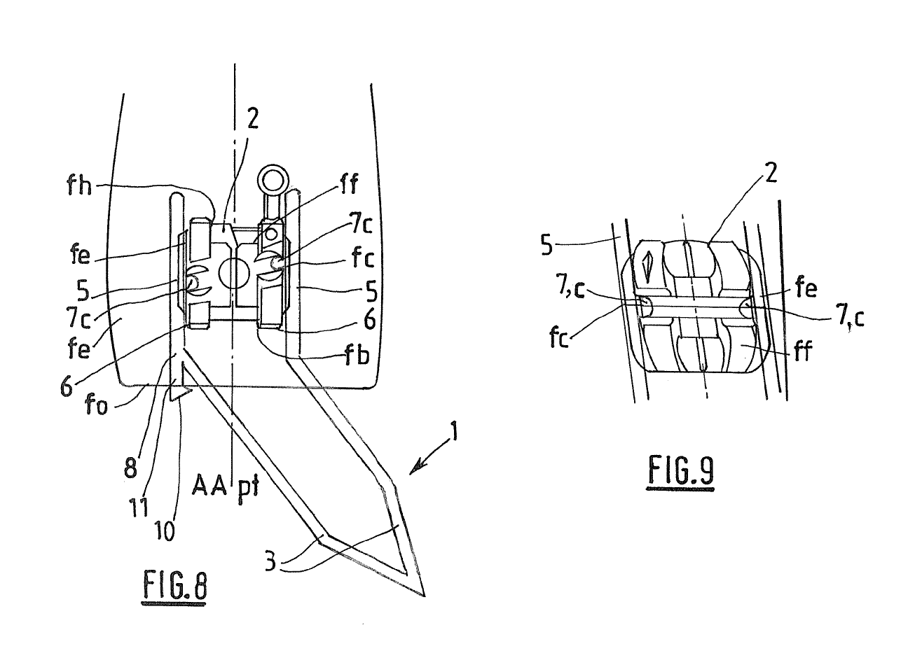

FIGS. 8 and 9 are two elevation views of two other variant embodiments of the tweezers.

The tweezers 1 are designed for positioning—and most often ultimately for rigid engagement of (by means of glue or the like)—an orthodontic lock 2 on a tooth—or a tooth model—d. Throughout the description and in the claims, the word “tooth” means both the tooth of a patient and a tooth model, as is known in the field of orthodontia.

For the requirements of the description, the following are defined, concerning the tooth d, its AA axis, its occlusal surface fo, its inside surface fi and its outside surface fe, its longitudinal plane pl (plane of FIGS. 4 and 6), and its transverse plane pt (plane of FIGS. 5 and 7).

It is understood that the invention applies to any tooth—incisor, canine, premolar, or molar—that can accommodate an orthodontic lock 2. Such a tooth d is part of a jaw and belongs either to its lower archway (FIGS. 4 and 5) or its upper archway (FIGS. 6 and 7).

The orthodontic lock 2, both as a whole and in its constituent parts, can be the object of various structural variants, concerning both its design as well as its embodiment.

One example of an orthodontic lock 2 to which the tweezers 1 are well adapted—in this case, a self-locking lock—is described in the document WO 2006/097657.

For the requirements of the description, the following is defined concerning the orthodontic lock 2, a support surface fa, namely the surface that is designed to be interlocked between a corresponding surface fi or fe of the tooth d. In addition, the lock 2 is generally integrated into a jacket that is generally shaped like a parallelepiped or pseudo-parallelepiped and that comprises a front surface ff that is opposite to the support surface fa, two respective top fh and bottom fb lateral surfaces and two lateral surfaces on the side fc.

It is understood that the terms “lower,” “upper,” “top,” “bottom,” “vertical,” “horizontal,” “above,” “below,” . . . are meant to refer to a tooth or a dentition of a patient facing forward. However, it is understood that the tweezers 1, like the orthodontic locks 2, can occupy positions other than those corresponding to their use on the person in question. These terms are therefore illustrative but nonlimiting.

The expression “when the tweezers are in use,” occasionally used, corresponds to the position of tweezers 1 that support an orthodontic lock 2 and are arranged—since they are placed thus by the orthodontist—such that the orthodontic lock 2 is placed against the tooth in the desired position and with the desired orientation. The terms “lower,” “upper,” “top,” “bottom,” “vertical,” “horizontal,” “above,” “below” . . . also refer to this position, whereby the tooth is in the position that was just indicated.

The orthodontic lock 2, in the embodiment considered here, also comprises a groove g, commonly called a slot, that is designed to accommodate an arc. The groove g empties onto the front surface ff by an elongated groove inlet eg. The groove g also empties onto the two lateral surfaces of side fc by holes t.

In one embodiment, the orthodontic lock 2 comprises a first bottom portion that includes the support surface fa and a second portion including the groove g. If necessary, a certain incline between these two portions is provided.

For a given archway, several orthodontic locks 2 that are located on different teeth—successive or not—of the archway, through which the same arc passes, are provided.

The tweezers 1 first comprise two manipulating arms 3 with elastic means, leading to the tendency, in the absence of any external force, for the tweezers 1 to be closed, the bits 5 thereof against one another.

The elastic means consist of the arms themselves that have an inherent elasticity.

The two manipulating arms 3 have a sufficient length to allow manipulation (movement, opening, closing, . . . ) by the orthodontist or his staff.

According to a typical embodiment, the two manipulating arms 3 cross at a point that is close to the bits 5, such that the tweezers 1 are opened by resting on the arms that are separate from the bits 5.

The two manipulating arms 3 define a primary plane of symmetry ps, on both sides of which are each of the two manipulating arms 3.

The two manipulating arms 3 are joined to one another by one of their ends 4.

The two manipulating arms 3 are terminated at their other opposite end by two bits 5, each limited by an inside, essentially plane, surface 6.

The two inside surfaces 6 are essentially parallel to one another.

In the embodiment of FIGS. 4 to 8, the two inside surfaces 6 of the bits 5 are parallel to the primary plane of symmetry ps of the two manipulating arms 3.

In the embodiment of FIG. 9, the two inside surfaces 6 of the bits 5 are inclined by an angle α on the plane ps. This embodiment is suited to the case of an orthodontic lock 2 whose portion including the groove g has an incline with the bottom portion including the support surface fa. The angle α can be, for example, on the order of several degrees, more generally less than 30°.

The bits 5 are designed for gripping the orthodontic lock 2 for the purpose of positioning it and orienting it, and most often ultimately interlocking it on a tooth d in the desired location and with the desired orientation.

The size of the bits 5 is at least approximately equal to that of the lateral surfaces on the side fc of the orthodontic lock 2, such that they at least essentially envelop the lateral surfaces on the side fc of the orthodontic lock 2.

The tweezers 1 comprise two projections 7 facing one another, made on the two inside surfaces 6 of the two bits 5, in this case in their median portion.

In this case, a projection 7 is in the form of a piece that is generally cylindrical in shape and, in the general embodiment, with a diameter that is adapted to the size of the slot g.

The two projections 7 are arranged so as to be able to work in a removable manner, with adjustment, with two recesses c that are opposite to one another, made on the two lateral surfaces on the side fc of the orthodontic lock 2. It is therefore understood that the tweezers 1 involve the use of such a type of orthodontic lock 2.

Working in a removable manner and with adjustment is defined as the fact that the play between the projections and the recesses c makes it possible to make the projections 7 penetrate into the recesses c, to remove them both without excessive effort, and, once combined, that there was no ill-timed significant lateral movement between them.

The outside surface of the projections 7 in the form of pieces and the conjugated inside surface of the recesses c of the orthodontic lock 2 are therefore smooth or at least smooth enough to allow the desired adjustment and removability.

In the embodiments shown, the two projections 7 are coaxial, just like the two recesses c. In this case, in addition, a possibility of relative pivoting, at least within a certain range, of projections 7 relative to the recesses c, i.e., the orthodontic lock 2 relative to the bits 5 and therefore relative to the tweezers 1, is provided. In this embodiment, the transverse straight cross-sections of the projections 7 in the form of pieces and recesses c of the orthodontic lock 2 are arranged to enable the desired pivoting; in particular these transverse straight cross-sections—at least one of the two conjugated sections—have a circular shape.

This structural arrangement is advantageous in that it has the effect that when the orthodontic lock 2 is applied firmly on the tooth d, for example for interlocking it, the support surface fa of the orthodontic lock 2 is fully applied on the corresponding surface fi or fe of the tooth d, without the risk of separating or gaping, as proves to be the case when gauges of the known prior art are used.

In the case of FIGS. 4 to 6, the two coaxial projections 7 have an axis that is perpendicular or essentially perpendicular to the respective inside surfaces 6 of the bits 5.

In the case of FIGS. 8 and 9, the two coaxial projections 7 have an axis that is inclined relative to the respective inside surfaces 6 of the bits 5 by an angle β. The angle β can vary from zero to about thirty degrees according to the technique that is used by the orthodontist.

The described structural arrangement with projections 7 and recesses c has as its function to ensure a positioning of the orthodontic lock 2 relative to the tweezers 1 that, setting aside the possibility of the above-mentioned relative pivoting, is known, precise, reproducible, without the risk of error, and thereby fast and easy.

In one embodiment, the recesses c consist of the holes t, i.e., the terminal portions of the groove g.

In another embodiment, the recesses c are separate from the holes t.

The positioning of the projections 7 on the inside surfaces 6 and the positioning of the recesses c on the lateral surfaces on the side fc correspond to the desired relative position of the orthodontic lock 2 relative to the tweezers 1.

The tweezers 1 also comprise at least one—and in the case of the embodiments shown in the figures only one—extension 8 that extends from a free end 9 of one of the bits 5.

This extension 8 extends, relative to this free end 9, with an incline and over a length that are suitable for the function that is performed, as disclosed below.

The extension 8 is actually designed, first of all, to be capable of—when the tweezers 1 are in use—extending essentially parallel to the AA axis of the tooth d in the direction of the occlusal surface fo.

The extension 8 is then designed to enable—when the tweezers 1 are in use—a return 10, being part of the tweezers 1 and described below, to come to a stop on the occlusal surface fo.

Actually, in addition, the tweezers 1 comprise at least one—and in the case of the embodiments shown in the figures only one—return 10 that extends crosswise from a free end 11 of the extension 8. This end 11 is facing the edge 9a.

In the embodiments that are shown in the figures, the extension 8 has a general fine rod shape or an equivalent shape that is arranged essentially vertically when the tweezers 1 are in use.

The extension 8 extends the edge of end 9a of the bits 5 starting from one of its ends 9 (depending on the destination of the tweezers as disclosed below), whereby the extension 8 and the edge 9a are at least essentially co-planar or co-linear.

When the tweezers 1 are in use, the edge 9a is parallel to the surface fi or fe of the tooth d on which the orthodontic lock 2 is designed to be positioned, oriented, and interlocked.

The return 10 also has the general shape of a fine rod, or an equivalent shape.

The extension 8 and the return 10 can constitute a one-piece system with the remainder of the tweezers 1.

In the general case, the return 10 essentially extends in a direction that is essentially perpendicular to the extension 8 and in the direction that extends the two manipulating arms 3 such that when the tweezers 1 are in use, the return 10 is at least essentially orthogonal to the longitudinal plane pl of the tooth d, while facing the tooth d itself to be able to interfere with its occlusal surface fo by a suitable vertical sliding movement.

In the case of a pointed tooth d, a return 10 generally in the shape of a strip, or in an equivalent shape, i.e., extending on the surface, is provided, whereby the return 10 thus extends not only in the first above-mentioned direction but also in a second direction that is perpendicular to the first. Because of this structural arrangement, when the tweezers 1 are in use, the return 10 also extends in the longitudinal plane pl of the tooth d toward its transverse plane pt, and it is ensured that the return 10 can interfere with the tooth d.

In the embodiment with a single extension 8 and a single return 10, this extension 8 and this return 10 are combined with one of the two bits 5, whereby the other is not involved.

In another possible embodiment, the tweezers 1 comprise two extensions and two returns such as 8 and 10. These two pairs of an extension and a return 8, 10 are similar. Each pair of an extension and a return 8, 10 is combined with a bit 5.

The structure, the dimensions and the inclines of the tweezers 1 are especially adapted to the tooth d for which it is intended. Such is the case, in particular, of the length of the extension 8 that conditions the vertical position of the orthodontic lock 2 on the tooth d, which is a parameter that conditions the operation of the orthodontia system with the combined lock and arc. Thus, the shorter the extension 8, the better the orthodontic lock 2 will be placed on the tooth d in proximity to the occlusal surface fo. Conversely, the longer the extension 8, the better the orthodontic lock 2 will be placed on the tooth d far from the occlusal surface fo.

Preferably, several lengths that are typical corresponding to standard implantations are provided for the extension 8.

Furthermore, the structure of the tweezers 1 depends on its destination, namely a tooth d of the lower archway or a tooth d of the upper archway of the jaw. Actually, the respective relative positions of the occlusal surfaces fo relative to the tweezers 1, more especially to the bits 5, can be termed facing one another.

In the case of tweezers 1 that are especially designed for the lower archway of the jaw (FIGS. 4 and 5), the extension 8 extends toward the top of the tweezers 1. In this arrangement, the extension 8 is located above the projections 7, and the return 10 is located above the extension 8, whereby the orthodontic lock 2 is placed below the occlusal surface fo.

Conversely, in the case of tweezers 1 that are especially designed for the upper archway of the jaw (FIGS. 6 and 7), the extension 8 extends downward from the tweezers 1. In this arrangement, the extension 8 is located below the projections 7, and the return 10 is located below the extension 8, whereby the orthodontic lock 2 is placed above the occlusal surface fo.

In one of the cases, the extension 8 extends the edge of end 9a of the bit 5 from its first end 9, while in the other case, the extension 8 extends the edge of end 9a of the bit 5 from its second end 9.

The invention also relates to a unit that comprises tweezers 1 and a suitable orthodontic lock 2, as they have been described. Such a unit is intended for an identified tooth d.

The invention also relates to a system that comprises a number of such units, whereby each unit corresponds to one of the teeth d of a jaw that has to accommodate an orthodontic lock 2. The orthodontist therefore has at his disposal tweezers 1 and orthodontic locks 2 as well as teeth d to be equipped, each unit being adapted to the tooth.

During use, these different units can be prepared on a tray.

The invention also relates to the process for using an orthodontic unit as has been described.

In this process, a start is made from a position in which an orthodontic lock 2 and tweezers 1 adapted to the lock 2 and to the tooth d in question are arranged.

Then, the orthodontic lock 2 is positioned manually between the two bits 5 of the tweezers 1.

For this purpose, the projections 7 of the tweezers 1 are placed in the recesses c of the orthodontic lock 2. The inside surfaces 6 of the bits 5 come against the lateral surfaces on the side fc of the orthodontic lock 2, by the effect of elastic means on the two manipulating arms 3 of the tweezers 1. Furthermore, the support surface fa of the orthodontic lock 2 is arranged toward the outside end of the tweezers 1 so that it can be exposed to the tooth d.

Then, the tweezers 1 that are thus equipped with the orthodontic lock 2 are manipulated so as to bring the support surface fa toward the surface fi or fe of the tooth d that has to accommodate the orthodontic lock 2.

Then, the orthodontic lock 2 is positioned in the desired location on the tooth d, with the desired orientation. For this purpose, the return 10 of the tweezers 1 is brought to a stop on the occlusal surface fo of the tooth d by means of a small vertical sliding movement.

According to one embodiment, in addition the interlocking of the orthodontic lock 2 on the tooth d is ensured by means of glue by the techniques that are known in orthodontia.

1. Tweezers (1) for positioning an orthodontic lock (2) on a tooth d, comprising two manipulating arms (3) with elastic means that are terminated by two bits (5) for gripping the lock (2) for the purpose of positioning it and most often interlocking it on a tooth d at the desired location and with the desired orientation, also comprising:
two projections (7) facing one another, made on the two inside surfaces (6) of the two bits (5), able to work in a removable manner, with adjustment, with two recesses c that are opposite one another and that are made on the two lateral surfaces fc of the lock (2),
at least one extension (8) that extends from a free end (9) of at least one of the bits (5) with an incline and over a suitable length at which the extension (8) is able, when the tweezers (1) are in use, to extend essentially parallel to the AA axis of the tooth d in the direction of the occlusal surface fo,
at least one return (10) extending crosswise from a free end (11) of at least one extension (8), able, when the tweezers (1) are in use, to come to a stop on the occlusal surface fo of the tooth d.

2. Tweezers (1) according to claim 1, characterized by two coaxial projections (7) that can work with two coaxial recesses c, with the possibility of relative pivoting at least within a certain range.

3. Tweezers (1) according to claim 1, characterized by two coaxial projections (7) with an axis that is essentially perpendicular to the respective inside surfaces (6) of the bits (5).

4. Tweezers (1) according to claim 1, characterized by two coaxial projections (7) with an inclined axis relative to the respective inside surfaces (6) of the bits (5).

5. Tweezers (1) according to claim 1, characterized by two bits (5) having two inside surfaces (6) that are parallel to the plane of symmetry ps of the tweezers (1).

6. Tweezers (1) according to claim 1, characterized by two bits (5) having two parallel inside surfaces (6), inclined relative to the plane of symmetry ps of the tweezers (1).

7. Tweezers (1) according to claim 1, characterized by a return (10) that extends essentially in a direction that can be found at least essentially orthogonal to the longitudinal plane pl of the tooth d.

8. Tweezers (1) according to claim 1, characterized by a return (10) that extends in two essentially perpendicular directions, a first direction that can be located at least essentially orthogonal to the longitudinal plane pl of the tooth d and a second direction that can be located at least essentially in the longitudinal plane pl of the tooth d in the direction of its transverse plane pt.

9. Tweezers (1) according to claim 1, characterized by dimensions and inclines that are especially adapted to the tooth d for which they are designed and according to the type of technique used by the orthodontist.

10. Tweezers (1) according to claim 1, characterized by a single extension (8) and a single return (10) on only one of the bits (5).

11. Tweezers (1) according to claim 1, characterized by two extensions (8) and two returns (10), one for each bit (5).

12. Tweezers (1) according to claim 1, wherein they are especially designed for the lower archway of the jaw, whereby an extension (8) extends upward from a bit (5).

13. Tweezers (1) according to claim 1, wherein they are especially designed for the upper archway of the jaw, whereby an extension (8) extends downward from a bit (5).

14. Unit that comprises tweezers (1) according to claim 1 and an orthodontic lock (2) that has two recesses c that are opposite to one another and that are made on the two lateral surfaces fc, able to work with the two projections (7) of the tweezers (1) in a removable manner and with adjustment.

15. System comprising a number of units according to claim 14, each unit corresponding to one of the teeth d that has to accommodate an orthodontic lock (2).
